(19) United States
(12) Patent Application Publication
(10) Pub. No.: US 2026/0031611 A1
(43) Pub. Date: Jan. 29, 2026

(54) INRUSH CURRENT CONTROL

(71) Applicant: Texas Instruments Incorporated, Dallas, TX (US)

(72) Inventors: Orlando Lazaro, CARY, NC (US); Youngbok Kim, SAN JOSE, CA (US); Aldrin J. Paynter, SAN JOSE, CA (US); Kevin Scoones, SAN JOSE, CA (US)

(21) Appl. No.: 18/782,085

(22) Filed: Jul. 24, 2024

(51) Int. Cl. H02H 9/00

(52) U.S. Cl. CPC H02H 9/001

(57) ABSTRACT

Described embodiments include a circuit having a first amplifier. A first amplifier input is coupled to a first reference source. A first switch is coupled between a current source and a ground terminal, and has a first switch control terminal coupled to the first amplifier output. A second amplifier has a third amplifier input coupled to a second reference source, and a fourth amplifier input coupled to the first switch. A third amplifier has a fifth amplifier input coupled to the second amplifier output, and a sixth amplifier input coupled to a third reference source. A second switch has a first switch terminal coupled to the fifth amplifier input, and a second switch control terminal coupled to the third amplifier output. A current mirror has a current mirror input coupled to the second switch terminal, and a current mirror output coupled to the second amplifier input.

### BACKGROUND

This description relates to power management integrated circuits (PMICs) for voltage converters and the control of inrush current in buck voltage converters and similar circuits. One example of a situation where a significantly large current peaking can occur in a buck voltage converter is when the voltage converter transitions from maximum duty cycle operation to operating at a lower duty cycle. A buck voltage converter regulates a higher DC input voltage to a specified lower DC output voltage.

In cases where the input voltage is close in value to the output voltage, the buck voltage converter typically operates at its maximum duty cycle. Operating the buck voltage converter at its maximum duty is usually not a problem in most cases. However, issues can occur when the buck voltage converter transitions from operating at its maximum duty cycle to operating at a lower duty cycle. One such issue is that a significantly large current peak may occur on the incoming current line. If this current peaking occurs and is not mitigated, it can result in damage to downstream electronics that are connected to the buck voltage converter.

### SUMMARY

In a first example, a circuit includes a first amplifier having first and second amplifier inputs and a first amplifier output. The first amplifier input is coupled to a first reference source. A first switch is coupled between a current source and a ground terminal, and has a first switch control terminal that is coupled to the first amplifier output. A second amplifier has third and fourth amplifier inputs and a second amplifier output. The third amplifier input is coupled to a second reference source, and the fourth amplifier input is coupled to the first switch.

A third amplifier has fifth and sixth amplifier inputs, and a third amplifier output. The fifth amplifier input is coupled to the second amplifier output, and the sixth amplifier input is coupled to a third reference source. A second switch has first and second switch terminals and a second switch control terminal. The first switch terminal is coupled to the fifth amplifier input, and the second switch control terminal is coupled to the third amplifier output.

A current mirror has a current mirror input and a current mirror output. The current mirror input is coupled to the second switch terminal, and the current mirror output is coupled to the second amplifier input.

In a second example, a circuit includes a first transistor having first and second current terminals, and a first transistor control terminal. The second current terminal is coupled to the first transistor control terminal. A second transistor has third and fourth current terminals and a second transistor control terminal. The third current terminal is coupled to the first current terminal, and the second transistor control terminal is coupled to the first transistor control terminal.

A first amplifier has first and second amplifier inputs and a first amplifier output. The first amplifier input is coupled to a first reference source, and the second amplifier input is coupled to the fourth current terminal. A first switch is coupled between a current source and a ground terminal, and has a first switch control terminal that is coupled to the first amplifier output. A second amplifier has third and fourth amplifier inputs, and a second amplifier output. The third amplifier input is coupled to a second reference source. The fourth amplifier input is coupled to the first switch.

A third amplifier has fifth and sixth amplifier inputs and a third amplifier output. The fifth amplifier input is coupled to the second amplifier output, and the sixth amplifier input is coupled to a third reference source. A second switch has first and second switch terminals and a second switch control terminal. The first switch terminal is coupled to the fifth amplifier input, and the second switch control terminal is coupled to the third amplifier output.

A third transistor is coupled between the second switch terminal and the ground terminal, and has a third transistor control terminal that is coupled to the second switch terminal. A fourth transistor is coupled between the second current terminal and the ground terminal, and has a fourth transistor control terminal coupled to the third transistor control terminal.

### BRIEF DESCRIPTION OF THE DRAWINGS

FIG. 1 shows a schematic diagram for an example controller for a buck voltage converter.

FIG. 2 shows a timing diagram for an example controller for a buck voltage converter.

FIG. 3 shows a schematic diagram for an example controller for a buck voltage converter with a regulated control loop voltage.

### DETAILED DESCRIPTION

In this description, the same reference numbers depict same or similar (by function and/or structure) features. The drawings are not necessarily drawn to scale.

In many cases, power management integrated circuits (PMICs) are specified to accept a wide range of input voltages and provide a specified regulated output voltage. A buck voltage converter regulates a DC input voltage provided at a higher voltage to a specified DC output voltage at a lower voltage. In cases where the input voltage is close in value to the output voltage, a switching buck voltage converter typically operates at near its maximum duty cycle.

Entering and operating at maximum duty cycle does not usually present a problem for buck voltage converters in most cases. However, an issue can occur when the buck voltage converter transitions out of maximum duty cycle operation. In that condition, an internal voltage loop control signal may be set significantly higher than the value necessary to operate at maximum duty cycle. When operating at maximum duty cycle, the internal control signal reaches a maximum value and clamps. Then, when the converter transitions out of maximum duty cycle operation by either increasing the input voltage or pulling down the output voltage with a heavy load transient, the internal voltage loop control signal may remain higher than necessary, leading to a large input current overshoot peak until the control loop can recover, take control, and limit the duty cycle to a steady-state value.

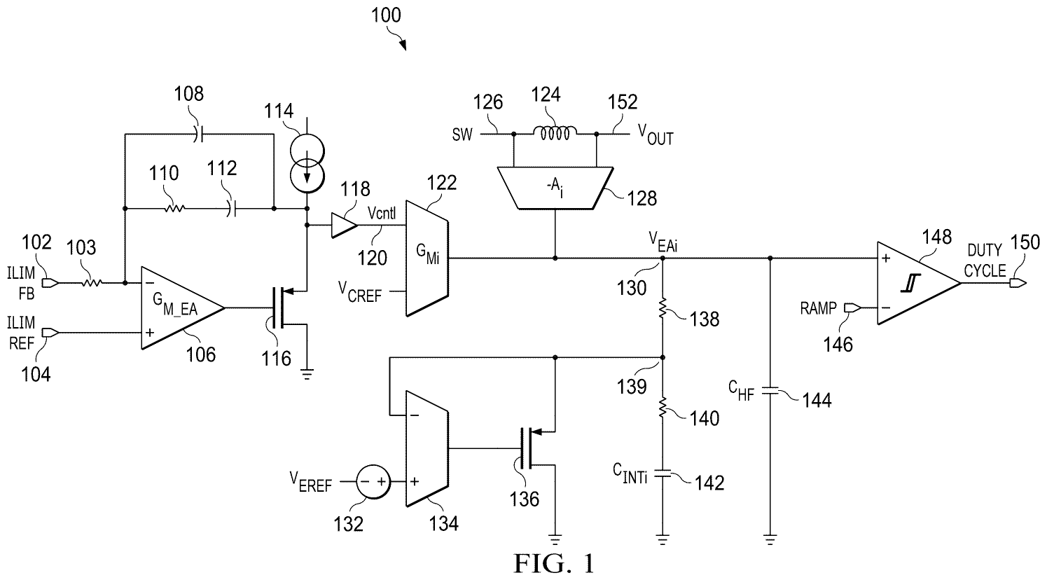

FIG. 1 shows a schematic diagram for an example controller 100 for a buck voltage converter. Amplifier G_{M_EA} 106 has an inverting input that is coupled to a current feedback terminal ILIM_FB 102. ILIM_FB 102 is a voltage that is proportional to an input current of the buck voltage converter. The input current may be measured through a current sense resistor or a current sensing circuit. Amplifier G_{M_EA} 106 has a non-inverting input that is coupled to a current limit reference terminal ILIM_REF 104. ILIM_REF 104 is a voltage that is proportional to a selected current limit for the buck voltage converter.

The output of amplifier G_{M_EA} 106 is coupled to the control terminal of transistor 116. In at least one example, transistor 116 is an n-channel field effect transistor (FET). The source of transistor 116 is coupled to a current source 114, and the drain of transistor 116 is coupled to a ground terminal. Resistor 110 and capacitor 112 are coupled in series between the inverting input of amplifier G_{M_EA} 106 and the source of transistor 116. Capacitor 108 is coupled between the inverting input of amplifier G_{M_EA} 106 and the source of transistor 116.

Buffer amplifier 118 has an input coupled to the source of transistor 116. The output of buffer amplifier 118 is coupled to a first input of transconductance amplifier 122 and provides a voltage loop control signal V_{CNTRL} 120. A second input of transconductance amplifier 122 is coupled to a reference voltage source that provides a reference voltage V_{CREF}. Resistor 138 is coupled between the output of transconductance amplifier 122 and resistor 140. Resistors 138 and 140 are coupled in series and form a voltage divider having a voltage divider midpoint 139 at the terminal connecting resistor 138 and resistor 140. Capacitor 142 is coupled between resistor 140 and the ground terminal.

Transistor 136 is coupled between the voltage divider midpoint 139 and the ground terminal. Amplifier 134 has an inverting input coupled to the voltage divider midpoint 139. Amplifier 134 has a noninverting input coupled to a reference voltage source that provides a reference voltage V_{EREF}. The output of amplifier 134 is coupled to the control terminal of transistor 136. Inductor 124 is coupled between an output voltage terminal V_{OUT} 152 of the buck voltage converter and a switching terminal SW 126 of a driver circuit (not shown) of the buck voltage converter.

Amplifier 128 has a first input coupled to the switching terminal SW 126, and a second input coupled to the output voltage terminal V_{OUT} 152 of the buck voltage converter. The output of amplifier 128 provides a voltage proportional to the current through inductor 124. The output of transconductance amplifier 122 provides a voltage proportional to the difference in voltage between the voltage loop control signal V_{CNTRL}. 120 and reference voltage V_{CREF}. The voltage at the output of transconductance amplifier 122 is summed with the voltage at the output of amplifier 128 to form the signal V_{EAI} 130.

A noninverting input of amplifier 148 is coupled to the output of transconductance amplifier 122 and to the output of amplifier 128, and receives the signal V_{EAI} 130. The inverting input of amplifier 148 is coupled to a ramp generator and receives a ramp signal 146. Capacitor 144 is coupled between the noninverting input of amplifier 148 and the ground terminal. The output of amplifier 148 is coupled to a gate driver circuit (not shown) of the buck voltage converter and provides a duty cycle signal 150.

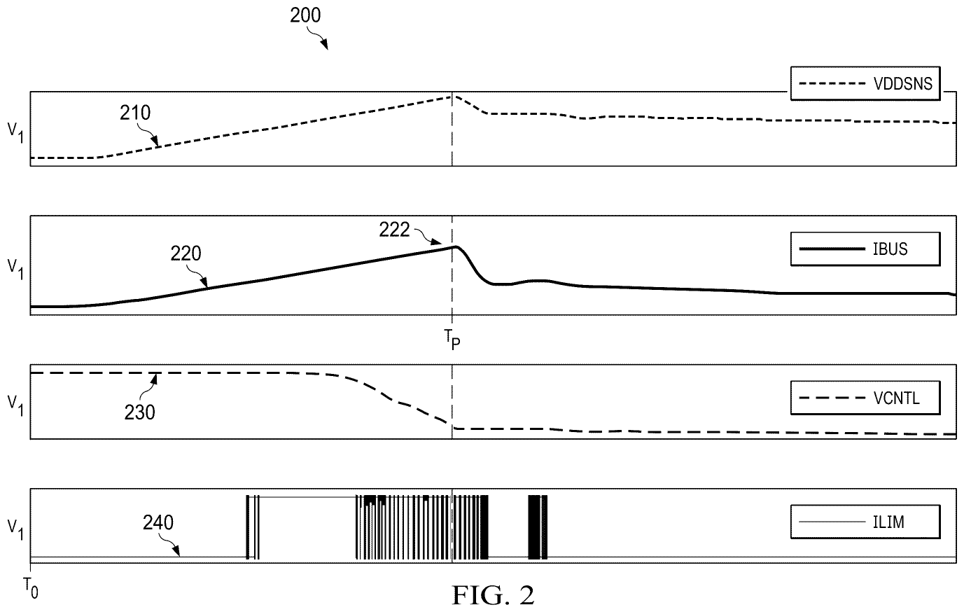

FIG. 2 shows a timing diagram 200 for an example buck voltage converter. In each of the curves in timing diagram 200 (e.g. 210, 220, 230, and 240), the x-axis is a plot of time and the y-axis is a plot of magnitude for each respective signal. Curve 210 is a plot of voltage versus time for the output voltage VDDSNS of a buck voltage converter. Curve 220 is a plot of current versus time for the input current IBUS of the buck voltage converter. Curve 230 is a plot of voltage versus time for the voltage loop control signal VCNTRL of the buck voltage converter. Curve 240 is a plot of voltage versus time for the current loop control signal ILIM of the buck voltage converter. ILIM provides a digital status signal indicating whether the current control loop is in control.

At time T₀, the buck voltage converter is operating at maximum duty cycle. The voltage loop control signal VCNTL 230 is clamped at a voltage V₁. The voltage loop control signal VCNTL controls the current through an inductor in the output stage of the buck voltage converter, and is used to control a voltage that determines the duty cycle of a gate driver that controls the transistors in the power stage of the buck voltage converter.

Due to the relatively high voltage on the voltage loop control signal VCNTL 230 when the buck voltage converter comes out of maximum duty cycle operation, the inductor current will also be relatively high. As the buck voltage converter transitions out of maximum duty cycle operation, the voltage loop control signal VCNTL 230 begins ramping down. But, the control signal voltage is still quite high because the gain of the voltage-to-current conversion is relatively high.

In at least one example, the gain of the voltage-to-current conversion was set at 25 amps per volt, which means that 40 mV equals 1 A of inductor current. This creates an inrush current through inductor 124. An outer current control loop tries to prevents this sudden inrush current. However, the bandwidth of the control loop is relatively narrow, making the control loop slow to respond to the inrush current. So, the control loop is not able to prevent this high inrush current through inductor 124.

In some cases, other control loops may attempt to regulate current and prevent a large input current inrush, but may also be too slow to prevent the inrush current due to inadequate bandwidth. Eventually, the control loop catches up and comes into control of the current, and the input current begins decreasing when the control signal becomes low enough. ILIM 240 is provided by the input current regulation loop, which detects the input current, compares it to a reference level, and regulates the input current level. The ILIM 240 curve is the output of the error amp for this loop. When ILIM 240 is high, the current regulation loop is regulating effectively. When ILIM 240 goes low and remains low, the current control loop is not properly regulating the current.

The buck voltage converter typically enters into maximum duty cycle operation when the input voltage to the buck voltage converter is near the output voltage of the buck voltage converter. The buck voltage converter then transitions out of maximum duty cycle operation when either the input voltage increases, or a load on the output suddenly increases and causes the output voltage to decrease.

Although operating at maximum duty cycle does not usually cause any problems for the buck voltage converter, a problematic issue can occur at the time the buck voltage converter transitions out of maximum duty cycle. Current on the input current IBUS 220 of the buck voltage converter may continue to build up as the buck voltage converter transitions out of maximum duty cycle reaching a peak voltage 222 at time Tp. The input current can reach undesirably high levels before the current control loop can react and regulate the current back down to the load demand level. In one example, the input current peak 222 was measured at more than 7 A.

A cause for this input current peak in response to the buck voltage converter transitioning out of maximum duty cycle is that while the buck voltage converter is operating at maximum duty cycle, the voltage loop control signal V_{CNTRL}. 120 is clamped at too high level (e.g. 1.5V). So, it takes a longer time for the voltage loop control signal V_{CNTRL}. 120 to drop enough to reduce the input current. When transitioning out of maximum duty cycle operation, the voltage loop control signal V_{CNTRL} 120 has to slew from the higher level down to the input current limit level. This slewing adds a time delay to the loop response that can lead to overshoot, causing the input current to continue ramping to a peak voltage 222.

One possible solution for preventing the current peaking is to regulate the voltage loop control signal V_{CNTRL} 120 while operating at maximum duty cycle to a level that is only slightly higher than its eventual steady-state signal level. Regulating the voltage loop control signal V_{CNTRL} 120 to a level only slightly above the steady-state signal level allows the current control loop to get under control and reduce the input current relatively quickly, thus minimizing the current overshoot.

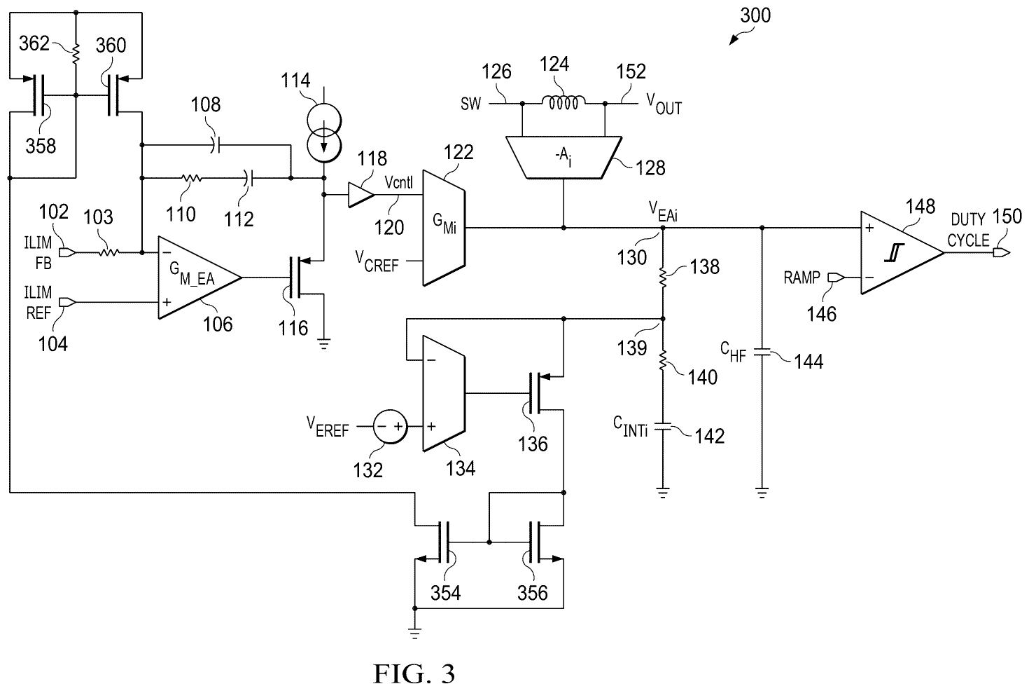

FIG. 3 shows a schematic diagram for an example controller 300 for a buck voltage converter with a regulated control voltage loop. Amplifier G_{M_EA} 106 has an inverting input that is coupled to a current feedback terminal ILIM_FB 102. ILIM_FB 102 is a voltage that is proportional to an input current of the buck voltage converter as measured through a current sense resistor or a current sensing circuit. Amplifier G_{M_EA} 106 has a non-inverting input that is coupled to a current limit reference terminal ILIM_REF 104. ILIM_REF 104 provides a voltage that is proportional to a selected current limit for the buck voltage converter.

The output of amplifier G_{M_EA} 106 is coupled to the control terminal of transistor 116. In at least one example, transistor 116 is an n-channel FET. The source of transistor 116 is coupled to a current source 114, and the drain of transistor 116 is coupled to a ground terminal. Resistor 110 and capacitor 112 are coupled in series between the inverting input of amplifier G_{M_EA} 106 and the source of transistor 116. Capacitor 108 is coupled between the inverting input of amplifier G_{M_EA} 106 and the source of transistor 116.

Buffer amplifier 118 has an input coupled to the source of transistor 116. The output of buffer amplifier 118 is coupled to a first input of transconductance amplifier 122 and provides a voltage loop control signal V_{CNTRL} 120. A second input of transconductance amplifier 122 is coupled to a reference voltage source providing a reference voltage V_{CREF}. Resistor 138 is coupled between the output of transconductance amplifier 122 and resistor 140. Resistors 138 and 140 are coupled in series and form a voltage divider having a voltage divider midpoint 139 at the connection between resistor 138 and resistor 140. Capacitor 142 is coupled between resistor 140 and the ground terminal.

Transistor 136 is coupled between the voltage divider midpoint 139 and transistor 356. Amplifier 134 has an inverting input coupled to the voltage divider midpoint 139. Amplifier 134 has a noninverting input coupled to a reference voltage source providing a reference voltage V_{EREF}. The output of amplifier 134 is coupled to the control terminal of transistor 136. Inductor 124 is coupled between an output voltage terminal V_{OUT} 152 of the buck voltage converter and a switching terminal SW 126 of a driver circuit (not shown) of the buck voltage converter.

Amplifier 128 has a first input coupled to the switching terminal SW 126, and a second input coupled to the output voltage terminal V_{OUT} 152 of the buck voltage converter. The output of amplifier 128 provides a voltage proportional to the current through inductor 124. The output of transconductance amplifier 122 provides a voltage proportional to the difference in voltage between the voltage loop control signal V_{CNTRL}. 120 and reference voltage V_{CREF}. The voltage at the output of transconductance amplifier 122 is summed with the voltage at the output of amplifier 128 to form the signal V_{EAI} 130.

A noninverting input of amplifier 148 is coupled to the output of transconductance amplifier 122 and the output of amplifier 128, and receives the signal V_{EAI} 130. The inverting input of amplifier 148 is coupled to a ramp generator and receives a ramp signal 146. Capacitor 144 is coupled between the noninverting input of amplifier 148 and the ground terminal. The output of amplifier 148 is coupled to a gate driver circuit (not shown) of the buck voltage converter and provides a duty cycle signal 150.

Transistor 356 is coupled between the drain of transistor 136 and the ground terminal. The control terminal of transistor 356 is coupled to the source of transistor 356 and to the drain of transistor 136. Transistor 354 is coupled between a drain of transistor 358 and the ground terminal. The control terminal of transistor 354 is coupled to the control terminal of transistor 356 and forms a current mirror with transistor 356. In at least one example, transistor 354 and transistor 356 are each n-channel FETs.

Transistor 358 forms a current mirror with transistor 360. The source of transistor 358 is coupled to the source of transistor 360. The control terminal of transistor 358 is coupled to the control terminal of transistor 360. The drain of transistor 358 is coupled to the drain of transistor 354. The drain of transistor 360 is coupled to the inverting input of amplifier G_{M_EA} 106. Resistor 362 is coupled between the drain of transistor 358 and the source of transistor 358.

The terminal providing the signal V_{EAI} 130 is a mixing terminal wherein the output of transconductance amplifier 122 is combined together with the inductor current information from the output of amplifier 128. The output of transconductance amplifier 122 is proportional to the difference between voltage loop control signal V_{CNTRL} 120 signal and a reference voltage V_{CREF}. The signal V_{EAI} 130 is provided to the noninverting input of amplifier 148. A ramp signal 146 from a ramp generator is provided to the inverting input of amplifier 148. The output of amplifier 148, which is the difference between V_{EAI} 130 and the value of the ramp signal 146, provides a duty cycle signal 150 to a gate driver circuit (not shown) of the buck voltage converter.

Resistors 138 and 140 form a voltage divider of the voltage at V_{EAI} 130 at a voltage divider midpoint 139. If the voltage at the voltage divider midpoint 139 becomes higher than the threshold voltage V_{EREF} 132, this indicates that the buck voltage converter is operating at or near its maximum duty cycle. In at least one example, the maximum duty cycle is clamped at 98.5%. A clamp in the control loop engages in response to the voltage at the voltage divider midpoint 139 becoming higher than the threshold voltage V_{EREF} 132. When the voltage at the voltage divider midpoint 139 becomes higher than the threshold voltage V_{EREF} 132, the output of amplifier 134 provides a voltage to the gate of transistor 136 to turn on transistor 136. Transistor 136 turning on produces a current from the voltage divider midpoint 139 that flows through transistor 136. The current through transistor 136 is then mirrored through the current mirror formed by transistor 354 and transistor 356.

Amplifier 134 acts as a current sensor and compares the sensed current to a reference voltage V_{CREF}. Turning on transistor 136 prevents the voltage at V_{EAI} 130 from rising higher than the threshold. The current mirror created by transistor 354 and transistor 356 produces a cloned version of the current through transistor 136, and mirrors that current into the inverting input of amplifier G_{M_EA} 106 through a second current mirror formed by transistor 358 and 360. Amplifier G_{M_EA} 106 is the error amplifier for the current regulation loop.

If the voltage at the voltage divider midpoint 139 becomes higher than the threshold voltage V_{EREF} 132, a sensor current flows through the first current mirror made up of transistors 354 and 356. The sensor current flows through the second current mirror made up of transistors 358 and 360. The current mirrors are needed due to headroom issues between transistor 136 and the inverting input of amplifier G_{M_EA} 106. Each of the two current mirrors provides a signal polarity inversion. So, two current mirrors are necessary to keep the polarity of the overall feedback loop negative. If only a single current mirror was present between transistor 136 and the inverting input of amplifier G_{M_EA} 106, the output of the single current mirror would provide positive feedback to the loop, making the loop unstable, and the voltage loop control signal V_{CNTRL} 120 would latch high.

As the sensor current increases, the voltage at the inverting input of amplifier G_{M_EA} 106 increases. This pulls down the voltage at the voltage loop control signal V_{CNTRL}. 120, which pulls down the voltage at V_{EAI} 130. The voltage at V_{EAI} 130 is regulated to be equal to the threshold voltage V_{EREF} 132. The voltage of the voltage loop control signal V_{CNTRL}. 120 is not clamped to a higher static value as it is in controller 100, but is instead regulated to just high enough voltage to make the voltage at V_{EAI} 130 equal to the threshold voltage V_{EREF} 132.

Inductor 124 is coupled between the switching terminal SW 126 and the output of the voltage converter V_{OUT} 152. Amplifier 128 senses the inductor current. The V_{EAI} 130 terminal adds the sensed inductor current from the output of amplifier 128 with a current signal that is proportional to the difference between the voltage loop control signal V_{CNTRL}. 120 and reference voltage V_{CREF}. When the buck voltage converter is operating at steady state, the AC voltage at the output of amplifier 128 is equal to the AC voltage at the output of transconductance amplifier 122, so there is no AC component to the voltage at V_{EAI} 130. This signal is provided to the first input of amplifier 148. The second input to amplifier 148 is a ramp signal 146 from a ramp generator (not shown). In at least one example, amplifier 148 is a Schmitt trigger comparator.

In at least one example, the ramp signal 146 is a sawtooth waveform that is continuously running at a constant frequency. However, in other examples, the ramp signal 146 may have a different waveform, for example a triangle wave, square wave, or sine wave. The ramp signal 146 is compared to the voltage at V_{EAI} 130 in amplifier 148 to produce the duty cycle signal 150 that is provided to the gate driver (not shown) for the high side and low side drive FETs of the buck voltage converter.

Current must be flowing through transistor 136 to create a voltage drop across the voltage divider for the control loop regulation to operate properly. This current is the sense current that is mirrored through the first current mirror consisting of transistors 354 and 356, and the second current mirror consisting of transistors 358 and 360. The sense current is provided to the inverting input of amplifier G_{M_EA} 106. The sense current creates a voltage drop across resistor 103, which is also connected to the current feedback terminal ILIM_FB 102. The input to the noninverting input of amplifier G_{M_EA} 106 is coupled to the current limit reference terminal ILIM_REF 104.

When the signal at the inverting input of amplifier G_{M_EA} 106 is equal to the voltage at the current limit reference terminal ILIM_REF 104, the buck voltage converter is operating at its maximum duty cycle, meaning that the input voltage to the buck voltage converter is close to the output voltage of the buck voltage converter. The control loop uses the current sense signal provided by transistor 136 and the first and second current mirrors to regulate the voltage loop control signal V_{CNTRL}. 120 to remain low enough while the buck voltage converter is operating at maximum duty cycle to prevent input current overshoot when the buck voltage converter transitions out of maximum duty cycle operation.

The control loop allows regulation of the voltage loop control signal V_{CNTRL} 120 to the correct value, and maintaining that value as conditions change. If the voltage loop control signal V_{CNTRL}. 120 is clamped at a voltage that is too high, input current overshoot can occur as the buck voltage converter transitions out of maximum duty cycle operation. If the voltage loop control signal V_{CNTRL}. 120 is clamped at a voltage that is too low, the control loop will be slow responding to changes in conditions and may not provide accurate control due to changes in temperature, process corner, and line voltage conditions. So, it is not possible to find a single clamp voltage value for the voltage loop control signal V_{CNTRL} 120 that will provide the same or better level of performance as is possible using a control loop with feedback to regulate the voltage loop control signal V_{CNTRL} 120.

Controller 300 can also be used in a multi-phase voltage converter. The control signal (i.e. V_{EAI} 130) for each of the phases usually shares a common connection. If the control signal in any of the phases of the voltage converter becomes latched at its rail voltage, a clamp for each of the phases at its rail voltage will engage. The clamp for whichever phase engages first will drive the control loop for all of the phases because all the phases share a common connection. If each phase draws the same amount of current, then the clamps for all of the phases will be in synch, and it will be optimal for all the phases to clamp at the same time. However, this is often not the case.

If only one of the phases rails out at V_{EAI} 130 and the other phases do not, the clamp for the phase that railed out will provide a clamping signal to all the phases due to the common terminal causing all the phases to react, which would be undesirable. A solution to this is to add circuitry, such as a diode-connected NMOS transistor, to provide an analog OR function that receives the signal from all of the phases, and provides a true signal to all the phases if any of the phases produces a true signal. So, the signal from whichever phase goes into clamping will be used as feedback for all the phases.

Although this could be done with an AND function instead of an OR function, the OR function provides better stability and performance. If an AND function is used instead of an OR function, then a signal from one of the phases could be railed out, but the circuit would not react until all the other phases also railed out, which is not desirable. So, in order to ensure that voltage loop control signal V_{CNTRL}. 120 is well-controlled, an OR function is used in multiphase systems so that the circuit reacts to the first phase to rail out.

The clamping techniques of controller 300 are applicable to other circuits in addition to buck voltage converters. The clamping techniques of controller 300 are applicable to boost voltage converters, buck-boost voltage converters, low dropout (LDO) voltage converters, and any other circuit having essentially zero gain due to the converter transitioning into some sort of nonlinear mode where it is no longer controlling the parameter that it is intended to control.

In an LDO voltage converter, a similar problem can occur if the input voltage drops lower than the target regulated output voltage. Even if the output drive transistor had the ability to drop zero voltage with as much current as is needed at the output, the output voltage is still going to be too low. The feedback voltage error amplifiers will attempt to regulate the output voltage higher due to the voltage error, but will be unable to do so. When this occurs, the error amplifiers will hit their limit and rail out. Then, after the input voltage rises, delay in the response of the voltage control loop can cause the output voltage to overshoot in a manner similar to the current overshoot of controller 100. The same concept of using a feedback loop to set the control signal at the proper level can prevent a voltage overshoot in this situation.

A problem that can arise in some circuits is wind up. For light load conditions, some controllers for voltage converters may transition the voltage converter from operating in continuous conduction mode to operating in discontinuous conduction mode where there will be time periods where no power is delivered to the output. During those time periods of no power delivery, the voltage converter duty cycle is neither 0% nor 100%, but is instead tri-stated. However, the converter is still receiving the feedback signal, and may be trying to respond to it. This can lead to a runaway condition known as wind up.

Wind up occurs when one or more control signals are railed out, and an amplifier is receiving a feedback signal that the controller has no capability of responding to. Even when operating in discontinuous mode, if the output voltage is higher than the target voltage, the voltage converter may be unable to sink the current. If the converter can take no action, or has already taken all the action that it can, but the control loop is still attempting to respond to and integrating the error, the system will go into wind up. The configuration of controller 300 can help prevent wind up by setting the control signal level using a feedback loop to regulate the loop control signal so that it is able to prevent the loop control signal from railing out.

In this description, “terminal,” “node,” “interconnection,” “lead” and “pin” are used interchangeably. Unless specifically stated to the contrary, these terms generally mean an interconnection between or a terminus of a device element, a circuit element, an integrated circuit, a device, or other electronics or semiconductor component.

In this description, “ground” includes a chassis ground, an Earth ground, a floating ground, a virtual ground, a digital ground, a common ground and/or any other form of ground connection applicable to, or suitable for, the teachings of this description.

In this description, the term “couple” may cover connections, communications or signal paths that enable a functional relationship consistent with this description. For example, if device A generates a signal to control device B to perform an action, then: (a) in a first example, device A is coupled to device B by direct connection; or (b) in a second example, device A is coupled to device B through intervening component C if intervening component C does not alter the functional relationship between device A and device B, so device B is controlled by device A via the control signal generated by device A.

In this description, even if operations are described in a particular order, some operations may be optional, and the operations are not necessarily required to be performed in that particular order to achieve specified results. In some examples, multitasking and parallel processing may be advantageous. Moreover, a separation of various system components in the embodiments described above does not necessarily require such separation in all embodiments.

Modifications are possible in the described embodiments, and other embodiments are possible, within the scope of the claims.

What is claimed is:

1. A circuit, comprising:
a first amplifier having first and second amplifier inputs and a first amplifier output, wherein the first amplifier input is coupled to a first reference source;
a first switch coupled between a current source and a ground terminal, and having a first switch control terminal coupled to the first amplifier output;
a second amplifier having third and fourth amplifier inputs and a second amplifier output, wherein the third amplifier input is coupled to a second reference source, the fourth amplifier input is coupled to the first switch;
a third amplifier having fifth and sixth amplifier inputs and a third amplifier output, wherein the fifth amplifier input is coupled to the second amplifier output, and the sixth amplifier input is coupled to a third reference source;
a second switch having first and second switch terminals and a second switch control terminal, wherein the first switch terminal is coupled to the fifth amplifier input, and the second switch control terminal is coupled to the third amplifier output; and
a current mirror having a current mirror input and a current mirror output, wherein the current mirror input is coupled to the second switch terminal, and the current mirror output is coupled to the second amplifier input.

2. The circuit of claim 1, further comprising a fourth amplifier having seventh and eighth amplifier inputs and a fourth amplifier output, wherein the seventh amplifier input is coupled to a first inductor terminal, and the eighth amplifier input is coupled to a second inductor terminal, and the fourth amplifier output is coupled to the second amplifier output.

3. The circuit of claim 2, wherein the current mirror is a first current mirror, the current mirror input is a first current mirror input, and the current mirror output is a first current mirror output, and the circuit is further comprising a second current mirror having a second current mirror input and a second current mirror output, wherein the second current mirror input is coupled to the first current mirror output, and the second current mirror output is coupled to the second amplifier input.

4. The circuit of claim 2, further comprising:
a first resistor coupled between the second amplifier output and the fifth amplifier input; and
a second resistor coupled between the fifth amplifier input and the ground terminal.

5. The circuit of claim 2, further comprising a resistor and a capacitor coupled in series between the first switch and the second amplifier input.

6. The circuit of claim 1, further comprising a driver circuit having a driver input and a driver output, wherein the driver input is coupled to the first switch, and the driver output is coupled to the fourth amplifier input.

7. The circuit of claim 2, further comprising a fifth amplifier having ninth and tenth amplifier inputs, and a fifth amplifier output, wherein the ninth amplifier input is coupled to the second amplifier output, and the tenth amplifier input is coupled to a ramp generator source terminal.

8. The circuit of claim 7, wherein the ramp generator source terminal provides a sawtooth waveform.

9. The circuit of claim 5, wherein the capacitor is a first capacitor, and the circuit is further comprising a second capacitor coupled between the first switch and the second amplifier input.

10. The circuit of claim 2, wherein the first reference source provides a voltage representing a current limit.

11. A circuit, comprising:
a first transistor having first and second current terminals and a first transistor control terminal, wherein the second current terminal is coupled to the first transistor control terminal;
a second transistor having third and fourth current terminals and a second transistor control terminal, wherein the third current terminal is coupled to the first current terminal, and the second transistor control terminal is coupled to the first transistor control terminal;
a first amplifier having first and second amplifier inputs and a first amplifier output, wherein the first amplifier input is coupled to a first reference source, and the second amplifier input is coupled to the fourth current terminal;
a first switch coupled between a current source and a ground terminal, and having a first switch control terminal coupled to the first amplifier output;
a second amplifier having third and fourth amplifier inputs and a second amplifier output, wherein the third amplifier input is coupled to a second reference source, the fourth amplifier input is coupled to the first switch;
a third amplifier having fifth and sixth amplifier inputs and a third amplifier output, wherein the fifth amplifier input is coupled to the second amplifier output, and the sixth amplifier input is coupled to a third reference source;
a second switch having first and second switch terminals and a second switch control terminal, wherein the first switch terminal is coupled to the fifth amplifier input, and the second switch control terminal is coupled to the third amplifier output;
a third transistor coupled between the second switch terminal and the ground terminal, and having a third transistor control terminal coupled to the second switch terminal; and
a fourth transistor coupled between the second current terminal and the ground terminal, and having a fourth transistor control terminal coupled to the third transistor control terminal.

12. The circuit of claim 11, further comprising a fourth amplifier having seventh and eighth amplifier inputs and a fourth amplifier output, wherein the seventh amplifier input is coupled to a first inductor terminal, and the eighth amplifier input is coupled to a second inductor terminal, and the fourth amplifier output is coupled to the second amplifier output.

13. The circuit of claim 11, further comprising a resistor coupled between the first current terminal and the first transistor control terminal.

14. The circuit of claim 13, wherein the resistor is a first resistor, and the circuit is further comprising:
a second resistor coupled between the second amplifier output and the fifth amplifier input; and
a third resistor coupled between the fifth amplifier input and the ground terminal.

15. The circuit of claim 12, further comprising a resistor and a capacitor coupled in series between the first switch and the second amplifier input.

16. The circuit of claim 11, further comprising a driver circuit having a driver input and a driver output, wherein the driver input is coupled to the first switch, and the driver output is coupled to the fourth amplifier input.

17. The circuit of claim 12, further comprising a fifth amplifier having ninth and tenth amplifier inputs, and a fifth amplifier output, wherein the ninth amplifier input is coupled to the second amplifier output, and the tenth amplifier input is coupled to a ramp generator source terminal.

18. The circuit of claim 17, wherein the ramp generator source terminal provides a sawtooth waveform.

19. The circuit of claim 15, wherein the capacitor is a first capacitor, and the circuit is further comprising a second capacitor coupled between the first switch and the second amplifier input.

20. The circuit of claim 12, wherein the first reference source provides a voltage representing a current limit.
